(19) United States
(12) Patent Application Publication
(10) Pub. No.: US 2026/0250451 A1
(43) Pub. Date: Aug. 27, 2026

(54) GLYCEROL-BASED RESINS FOR 3-D PRINTING

(71) Applicant: The Board of Trustees of The University of Alabama, Tuscaloosa, AL (US)

(72) Inventors: Jason E. Bara, Tuscaloosa, AL (US); Zahra Pour, Tuscaloosa, AL (US); Sourav Chatterjee, Tuscaloosa, AL (US)

(21) Appl. No.: 19/545,390

(22) Filed: Feb. 20, 2026

Related U.S. Application Data
(60) Provisional application No. 63/761,499, filed on Feb. 21, 2025.

(51) Int. Cl. C08F 257/02; B29C 64/124; B29K 105/00; B29K 105/26; B33Y 70/00; C08F 2/50; C08F 120/14; C08J 3/09

(52) U.S. Cl. CPC C08F 257/02; B29C 64/124; B33Y 70/00; C08F 2/50; C08F 120/14; C08J 3/095; B29K 2105/0002; B29K 2105/26; C08J 2325/06

(57) ABSTRACT

Disclosed herein are glycerol-based (meth)acrylates useful in resins for 3-D printing. In some implementations, the resins further include a dissolved polymer component.

### CROSS-REFERENCE TO RELATED APPLICATIONS

The present application claims priority to and the filing benefit of U.S. Provisional Patent Application No. 63/761,499, filed on 21 Feb. 2025, which is incorporated herein by reference in its entirety.

### STATEMENT OF GOVERNMENT SUPPORT

This invention was made with government support under grant no. 2029387 awarded by the National Science Foundation. The government has certain rights in the invention.

### BACKGROUND

Glycerol, a water-soluble triol, is ubiquitously available and widely utilized across various industries. It serves as a beverage sweetener, an additive in the food and cosmetics sectors, and even an antifreeze agent, among other applications. This versatility makes glycerol a valuable compound, yet the increasing production, particularly as a byproduct of the biodiesel industry, has led to a significant surplus. Global biodiesel production was projected to reach 41.4 billion L by 2025, representing a 33% increase from 2015. This rapid growth is largely driven by efforts to reduce dependence on fossil fuels and promote renewable energy sources. However, for every 100 kg of biodiesel produced, ~10 kg of glycerol is generated as a co-product. Thus, identifying sustainable and innovative applications for excess glycerol are essential to ensure the continued viability of the biodiesel industry. The U.S. Department of Energy (DOE) identifies glycerol as one of 12 key building block chemicals that can be transformed into various high-value, bio-based chemicals and materials. The three hydroxyl groups on the glycerol molecule provide numerous opportunities for synthesizing a wide range of chemicals with diverse functional groups. The conversion of glycerol into industrial chemicals can be accomplished via catalytic pathways, such as oxidation, hydrogenation, esterification, transesterification, and etherification. These methods open a range of possibilities for transforming glycerol into value-added products for various industrial applications. Moreover, the hydroxyl functional moieties offer the potential to utilize glycerol as a monomer in the synthesis of more sustainable polymeric materials leading to various valuable applications expanding their industrial and commercial relevance.

The wide range of properties achievable through careful selection of backbone and pendant groups makes (meth)acrylate-based polymers essential in numerous applications, including fabrics, additives, packaging, printing inks, adhesives, construction materials, and automotive paints. This versatility contributes to their substantial global production, which exceeds 9 Mton annually. To shift the (meth)acrylate industry to bio-based materials, one strategy is to develop new bio-based pendant groups offering the same or improved properties compared to conventional, petroleum-derived pendant groups. This transformation would not only support sustainability but also meet the growing demand for eco-friendly materials in these critical industries.

The availability and use of 3D printing (or additive manufacturing (AM)) has greatly accelerated in the past decade, enabling the rapid transformation of ideas into physical parts with complex geometries through localized, layer-by-layer material deposition. Among the various 3D printing technologies available-such as Inkjet, Fused Deposition Modeling (FDM), Digital Light Processing (DLP), and Selective Laser Sintering (SLS). Stereolithography (SLA) is one of the most established, versatile, and cost-efficient methods. The strategy behind 3D photopolymerization involves using liquid-state monomers or oligomers that can be photopolymerized/crosslinked when exposed to a specific wavelength of light in the presence of a photoinitiator. Photopolymerization is generally considered to be a “green” process due to its energy efficiency and solvent-free nature.

The continuous growth of the resin market for SLA has prompted numerous companies and research groups to develop resins with a wide range of properties. Most commercial and multifunctional methacrylate-based monomers such as polyethylene glycol diacrylate (PEGDA), urethane dimethacrylate (UDMA), triethylene glycol dimethacrylate (TEGDMA), and bisphenol A-glycidyl methacrylate (Bis-GMA) are compatible with SLA printers. However, not all of the resins can meet the requirements for specialized applications, such as self-healing and shape-memory materials, which cannot be achieved using conventional resins. Additionally, sustainable and/or bio-based resins are increasingly favored due to their reduced environmental impact.

There remains a need for improved resin compositions for 3-D printing applications. There remains a need for reducing reliance on petroleum as a feedstock for plastics. There remains a need for additional methods for valorizing abundant compounds like glycerol. There remains a need for additional methods of upcycling plastics.

### BRIEF DESCRIPTION OF THE FIGURES

FIG. 1 depicts synthesis of 1,3-diether methacrylate monomers and their structures.

FIG. 2 depicts 10 wt % waste PS solution in MAA-DEP and the resulting 3D-printed discs.

FIG. 3 depicts FTIR spectra of a) 1,3-diether-2-methacrylate monomers and b) corresponding polymers.

FIG. 4 depicts photos of 3D printed samples: a) poly(MAA-DMP) discs on the build plate, b) poly(MAA-DEP), c) poly(MAA-DBP), d) poly(MAA-DMEP) and e) poly(MAA-DMEP)/PS10 printed as tensile bars (“dogbones”).

FIG. 5 depicts thermal properties: a) DSC and b) TGA of 3D-printed 1,3-diether methacrylate samples.

FIG. 6 depicts SEM images of cryo-fractured surfaces of a) pure Poly(MAA-DEP) and b, c) Poly(MAA-DEP)/PS10.

FIG. 7 depicts a) stress-strain curves b) and XRD patterns of 3D-printed 1,3-diether-2-methacrylate polymers.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes, from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Compounds disclosed herein may be provided in the form of acceptable salts, for example pharmaceutically acceptable salts. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate.

The term “alkyl” refers to a radical of a straight-chain or branched hydrocarbon group having a specified range of carbon atoms (e.g., a “C₁₋₁₆ alkyl” can have from 1 to 16 carbon atoms). An alkyl group can be a saturated alkyl group or an unsaturated alkyl group, i.e., an alkyl group having one or more carbon-carbon double/triple bonds, i.e., an alkenyl or alkynyl group. Unless specified to the contrary, an “alkyl” group includes both saturated alkyl groups and unsaturated alkyl groups.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. By way of example, a heteroC₁₋₆alkyl (which may also be designated a C₁₋₆heteroalkyl) group includes, but is not limited to, the following structures:

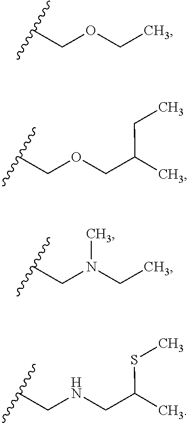

The term “heteroalkyl” preceded by a separate heteroatom refers to a heteroalkyl group bonded through the specified heteroatom. By way of example, a OC₁₋₆heteroalkyl group includes, but it not limited to, the following structures:

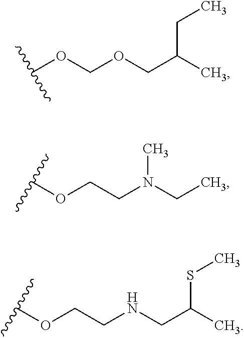

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

Affixing the suffix “-ene” to a group indicates the group is a polyvalent moiety, e.g., boned to two or more groups. Alkylene is the polyvalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl (each of which parent groups as defined herein).

The term “alkoxy” refers to an alkyl group, as defined herein, appended to the parent molecular moiety through an oxygen atom.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

Exemplary heteroaryl and heterocyclyl rings include: benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyL cirrnolinyl, decahydroquinolinyl, 2H,6H~1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, and xanthenyl.

Unless specified to the contrary, the alkyl, alkenyl, alkynyl, heteroalkyl, heteroalkenyl, heteroalkynyl, carbocyclyl, heterocyclyl, aryl, and heteroaryl groups defined herein (and the “ene” versions of said groups) may be substituted or unsubstituted. A substituted group includes a non-hydrogen substituent at a position where in the unsubstituted version a hydrogen atom would be found. Substituents include, but are not limited to, halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NR^{a}R^{b}, —NR^{a}C(═O)R^{b}, —NR^{a}C(═O)NR^{a}NR^{b}, —NR^{a}C(═O)OR^{b}, —NR^{a}SO₂R^{b}, —C(═O)R^{a}, —C(═O)OR^{a}, —C(═O)NR^{a}R^{b}, —OC(═O)NR^{a}R^{b}, —OR^{a}, —SR^{a}, —SOR^{a}, —S(═O)₂R^{a}, —OS(═O)₂R^{a} and —S(═O)₂OR^{a}. R^{a} and R^{b} in this context can be the same or different and independently hydrogen, halogen, hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, or heteroarylalkyl.

As used herein, the designation of a polyvalent moiety without specifying the specific order of attachment is intended to cover all possible arrangements. By way of example, a compound represented by the formula:

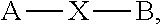

wherein X is NHC(═O) embraces both:

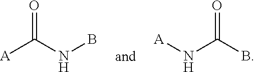

As used herein, a chemical bond depicted: [symbol] represents either a single, double, or triple bond, valency permitting. By way of example,

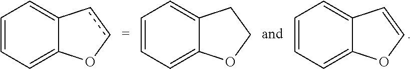

Some compounds disclosed herein may exist as one or more tautomers. Tautomers are interconvertible structural isomers that differ in the position of one or more protons or other labile atom. By way of example:

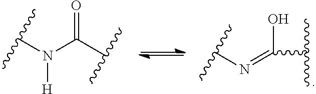

Unless stated to the contrary, a substituent drawn without explicitly specifying the point of attachment indicates that the substituent may be attached at any possible atom. For example, in a benzofuran depicted:

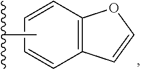

the substituent may be present at any one of the six possible carbon atoms.

As used herein, the term “null,” when referring to a possible identity of a chemical moiety, indicates that the group is absent, and the two adjacent groups are directly bonded to one another. By way of example, for a genus of compounds having the formula CH₃—X—CH₃, if X is null, then the resulting compound has the formula CH₃—CH₃. A group having the subscript ‘0’ is understood to represent a null group as well. By way of example, in the compound CH₃—(X)_{z}—CH₃, if X is CH₂ and z is 0, then the compound has the formula CH₃—CH₃.

A bracketed functional group with a subscripted variable should be understood to denote the number of repeated bracketed groups present. For example, a number that is selected from 0 or 1 should be interpreted as follows:

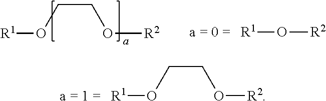

In certain instances, two or more variable groups may together form a ring. It is understood that any depicted atoms separated the identified groups will themselves form part of the ring:

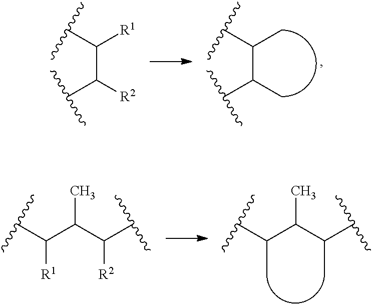

When the variable groups are substituted on an aromatic system the new ring will be a fused ring, and unless specified to the contrary may be either aromatic or non-aromatic, carbocyclic or heterocyclic:

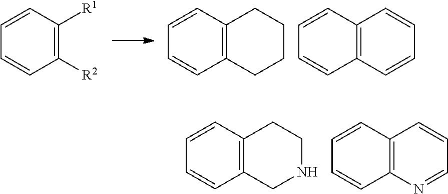

The ring may further be defined by the number of carbon atoms in the specific ring formed by the variable groups, which includes the atoms separating the variable groups:

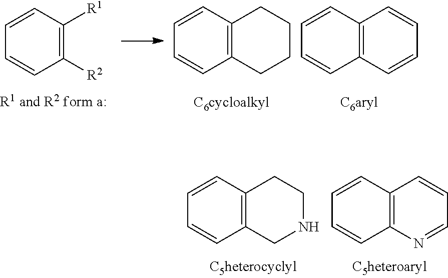

Each of the above results when R¹ and R² together form a six membered (or six atom) ring. Other rings, including 3, 4, 5, 7, and 8-member rings may also be formed, and may be further limited by a specified number of carbon atoms. Although the singular “a ring” may be used to define the group, unless specified to the contrary both monocyclic and polycyclic rings are possible:

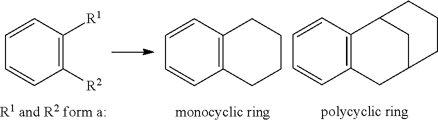

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture. Unless stated to the contrary, a formula depicting one or more stereochemical features does not exclude the presence of other isomers.

As used herein, the chemical group “D” refers to deuterium at an isotopic abundance greater than 25%, 35%, 50%, 60%, 70%, 80%, or 90%. In certain implementations, the chemical group “D” refers to deuterium at an isotopic abundance greater than 50%.

As used herein, the term “(meth)acrylate” embraces both acrylate and methacrylate.

As used herein, the term “allyl” refers to a functional group having the formula —CH₂—CH═CH₂.

As used herein, the term “vinyl” refers to a functional group having the formula —CH═CH₂.

Disclosed here are compositions including a compound having the formula:

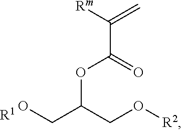

wherein
R^{m} is H or CH₃;
R¹ is C₁₋₁₂alkyl, C₃₋₁₂cycloalkyl, C₁₋₁₂heteroalkyl, C₆₋₁₂aryl, C₁₋₁₂heteroaryl, wherein R¹ can be substituted one or more times by halo, hydroxy, C₃₋₈cycloalkyl, C₁₋₈heterocyclyl, C₆₋₁₂aryl, C₁₋₁₂heteroaryl, or a combination thereof, and
R² is C₁₋₁₂alkyl, C₃₋₁₂cycloalkyl, C₁₋₁₂heteroalkyl, C₆₋₁₂aryl, C₁₋₁₂heteroaryl, wherein R² can be substituted one or more times by halo, hydroxy, C₃₋₈cycloalkyl, C₁₋₈heterocyclyl, C₆₋₁₂aryl, C₁₋₁₂heteroaryl, or a combination thereof.

In some implementations R¹ is a saturated C₁₋₁₂alkyl. In other implementation R¹ is an unsaturated C₁₋₁₂alkyl.

In some implementations R² is a saturated C₁₋₁₂alkyl. In other implementation R² is an unsaturated C₁₋₁₂alkyl.

In some implementations R¹ is methyl, ethyl, propyl, allyl, isopropyl, n-butyl, isobutyl, sec-butyl, t-butyl, n-pentyl, n-hexyl, n-heptyl, or 2-ethylhexyl, cyclopropyl, cyclobutyl, cyclopentyl, cyclohexyl, benzyl, phenyl, cinnamyl, 2,2,2-trifluoroethyl, trifluoromethyl, pentafluoroethyl, 2-methylphenyl, 3-methylphenyl, 4-methylphenyl, propargyl, furfuryl, diphenylmethyl, 2-phenylethyl, 2-yl-benzoate methyl ester, or cyclohex-3-enyl.

In some implementations R¹ is derived from a terpene alcohol, for example geranyl (derived from geraniol), (+)-citronellyl, (−)-citronellyl (derived from citrinellol), neryl (derived from nerol), nerolidyl (derived from nerolidol), linaloolyl (derived from linalool), or thymyl (derived from thymol).

In some implementations R¹ is 2-methoxyethyl, 2-ethoxyethyl, 3-methoxypropyl, 3-ethoxypropyl, —(CH₂CH₂O)ₙ—CH₃, —(CH₂)ₙ—O(CH₂)ₘ—CH₃, —(CH₂)ₙ—O(CF₂CF₃), wherein n is 1, 2, 3, 4, 5, or 6, and m is 1, 2, 3, 4, 5, or 6.

In some implementations R² is methyl, ethyl, propyl, allyl, isopropyl, n-butyl, isobutyl, sec-butyl, t-butyl, n-pentyl, n-hexyl, n-heptyl, or 2-ethylhexyl, cyclopropyl, cyclobutyl, cyclopentyl, cyclohexyl, benzyl, phenyl, cinnamyl, 2,2,2-trifluoroethyl, trifluoromethyl, pentafluoroethyl, 2-methylphenyl, 3-methylphenyl, 4-methylphenyl, propargyl, furfuryl, diphenylmethyl, 2-phenylethyl, 2-yl-benzoate methyl ester, or cyclohex-3-enyl.

In some implementations R² is derived from a terpene alcohol, for example geranyl, (+)-citronellyl, (−)-citronellyl, neryl, nerolidyl, linaloolyl, or thymyl.

In some implementations R² is 2-methoxyethyl, 2-ethoxyethyl, 3-methoxypropyl, 3-ethoxypropyl, —(CH₂CH₂O)ₙ—CH₃, —(CH₂)ₙ—O(CH₂)ₘ—CH₃, —(CH₂)ₙ—O(CF₂CF₃), wherein n is 1, 2, 3, 4, 5, or 6, and m is 1, 2, 3, 4, 5, or 6.

In some implementations R¹ and R² are the same. In other implementations R¹ and R² are not the same.

In some implementations the composition includes a polymer, for example at a concentration from 0.5-50 wt. %, from 1-50 wt. %, from 1-25 wt. %, from 1-10 wt. %, from 1-5 wt. %, from 5-10 wt. %, from 5-25 wt. %, from 10-20 wt. %, from 10-25 wt. %, from 10-50 wt. %, or from 25-50 wt. %. In certain implementations the polymer is dissolved or homogenously dispersed in the composition.

In some implementations the composition include a polyolefin, including fluoropolymers, polyesters, polyurethanes, polyamides, polycarbonates, poly(meth)acrylates, copolymers thereof, or a combination thereof.

In some implementations the composition include a polyethylene, polypropylene, polystyrene, polyvinyl chloride, polytetrafluoroethylene, polyvinyl fluoride, polyvinylidene fluoride, polyhexafluoropropylene, polyperfluorocycloalkene, perfluoropolyether, polychlorotrifluoroethylene, polyvinyl acetate, polyvinyl alcohol, polyurethane, polyamide 6, polyamide 66, polyamide 6T, polyamide, 4,6, polyamide 6,10, polyamide 6,12, polyacrylonitrile, polycarbonate, polylactic acid, polyethylene terephthalate, poly(propylene terephthalate), poly(methyl methacrylate), poly(butyl acrylate), poly(vinylimidazole), polyvinylpyrrolidone, poly(vinylpyridine), a combination thereof, or a copolymer thereof.

The composition of any preceding claim, wherein the composition comprises one or more crosslinker compounds. Exemplary crosslinker compounds include bis(meth)acrylate, bis(meth)acrylamide, divinyl compound, or combination thereof.

In some implementations the crosslinker is a compound having the formula:

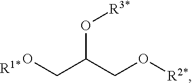

wherein
R¹* is H, C₁₋₈alkyl, C₃₋₈cycloalkyl, C₁₋₈heteroalkyl, allyl, or (meth)acrylyl;
R²* is H C₁₋₈alkyl, C₃₋₈cycloalkyl, C₁₋₈heteroalkyl, allyl, or (meth)acrylyl;
R³* is H, C₁₋₈alkyl, C₃₋₈cycloalkyl, C₁₋₈heteroalkyl, allyl, or (meth)acrylyl;
wherein (meth)acrylyl independently has formula:

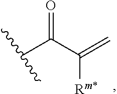

provided that at least two of R¹*, R²*, and R³* are allyl or (meth)acrylyl group

In some implementations the composition includes one or more crosslinkers selected from methylene bisacrylamide, ethylene glycol dimethacrylate, tetraethylene glycol dimethacrylate, trimethylolpropane trimethacrylate, ethoxylated trimethylol triacrylate, ethoxylated pentaerythritol tetracrylate, glycol (PEG)-thiol/PEG-acrylate, acrylamide/N,N′-bis(acryloyl)cystamine (BACy), (meth)acrylate-oligolactide-PEO-oligolactide (meth)acrylate, N,N′bis(acryloyl)cystamine, bisacrylamide, diacrylate, diallylamine, triallylamine, divinyl sulfone, diethylene glycol diallyl ether, ethylene glycol diacrylate, polyethylene glycol diacrylate, 1,4-phenylenediacryloyl chloride, and combinations thereof.

In some implementations the crosslinker is present at a concentration from 0.01-20 wt. %, from 0.1-10 wt. %, from 0.1-5 wt. %, from 0.1-2.5 wt. %, from 1-2.5 wt. %, from 1-5 wt. %, from 1-10 wt. %, or from 5-10 wt. %.

Also disclosed herein are methods of making an article by polymerizing the compositions disclosed herein. The compositions are especially suitable for 3-D printing applications, for example stereolithography. In some implementations the compositions are polymerized by exposing the composition to actinic radiation, heating the composition, or a combination thereof.

In certain implementations, the composition may include one or more initiator species, for example photoinitiator, a thermal initiator, or combination thereof. In some implementations the initiator can be selected from 1,1-azobis (cyclohexanecarbonitrile), ammonium persulfate, benzoyl peroxide, di-t-amylperoxide, tert-butyl peroxybenzoate, dicumylperoxide, azobisisobutyronitrile (AIBN), sodium metabisulfite, 4,4-azobis(4-cyanovaleric acid), 2,2-azobis(2,4-dimethylpentanenitrile), 2,2-azobis(cyclohexanecarbonitrile, acetophenone, 2-phenylacetophenone, 2-hydroxy-2-methylpro piophenone, 4-hydroxybenzophenone, 4,4-dihydroxybenzophenone, 4-(dimethylamino) benzophenone 4-ethoxyacetophenone, 4-phenoxyacetophenone, hexafluorophosphate, anthraquinone, anthraquinone-2-sulfonic acid, sodium salt monohydrate; tricarbonylchromium, benzoin based initiators, benzoin methyl ether, benzoin isobutyl ether, 2-hydroxy-4-(2-hydroxy ethoxy)-2-methylpropiophenone, benzil ketal based initiators dialkoxyacetophenone, hydroxyphenone, phenyl ketone, aminoalkylphenone, acylphosphine oxide, benzophenone, thioxanthone, azobisisobutyronitrile, lithium phenyl-2,4,6-trimethylbenzoylphosphinate, 1-hydroxy-cyclohexylphenylketone or blends, benzophenone tetracarboxylic dianhydride, methybenzoylformate, phenanthrenequinone, ferrocene, triarylsulfonium hexafluorophosphate salt, phenylbis(2,4,6-trimethylbenzoyl) phosphine oxide, and combinations thereof.

In certain implementations the initiator is present at a concentration from 0.01-10 wt. %, from 0.1-5 wt. %, from 0.1-2.5 wt. %, from 0.1-1 wt. %, from 0.1-0.5 wt. %, from 1-5 wt. %, from 1-2.5 wt. %, from 2.5-7.5 wt. %, or from 5-10 wt. %.

Also disclosed herein are methods of upcycling a polymer, wherein a preexisting polymer is incorporated in the resin composition that is then 3-D printed or otherwise converted into useful items. Because the disclosed compositions can dissolve or otherwise homogenously disperse the polymer throughout the resin composition, the dissolved polymer is evenly dispersed in the polymerized article.

In one implementation the method includes the step of combining a polymer in a composition comprising a compound having the formula:

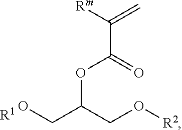

wherein R^{m}, R¹, and R² are as defined above, and polymerizing the resulting mixture to form an article.

In one implementation polymer is added to a concentration from 0.5-50 wt. %, from 1-50 wt. %, from 1-25 wt. %, from 1-10 wt. %, from 1-5 wt. %, from 5-10 wt. %, from 5-25 wt. %, from 10-20 wt. %, from 10-25 wt. %, from 10-50 wt. %, or from 25-50 wt. %.

In some implementations the polymer comprises a polyolefin, including fluoropolymers, a polyester, a polyurethane, a polyamide, a polycarbonate, poly(meth)acrylate, copolymers thereof, or a combination thereof.

In certain implementations, the polymer comprises a polyethylene, polypropylene, polystyrene, polyvinyl chloride, polytetrafluoroethylene, polyvinyl fluoride, polyvinylidene fluoride, polyhexafluoropropylene, polyperfluorocycloalkene, perfluoropolyether, polychlorotrifluoroethylene, polyvinyl acetate, polyvinyl alcohol, polyurethane, polyamide 6, polyamide 66, polyamide 6T, polyamide, 4,6, polyamide 6,10, polyamide 6,12, polyacrylonitrile, polycarbonate, polylactic acid, polyethylene terephthalate, poly(propylene terephthalate), poly(methyl methacrylate), poly(butyl acrylate), poly(vinylimidazole), polyvinylpyrrolidone, poly(vinylpyridine), a combination thereof, or a copolymer thereof.

Because the disclosed compositions are uniquely able to dissolve many different polymer species, costly pre-sorting procedures that are associated with other types of polymer recycling/upcycling can be avoided.

### Examples

The following examples are for the purpose of illustration of the invention only and are not intended to limit the scope of the present invention in any manner whatsoever.

### Synthesis of 1,3-Diether-2-Methacrylates

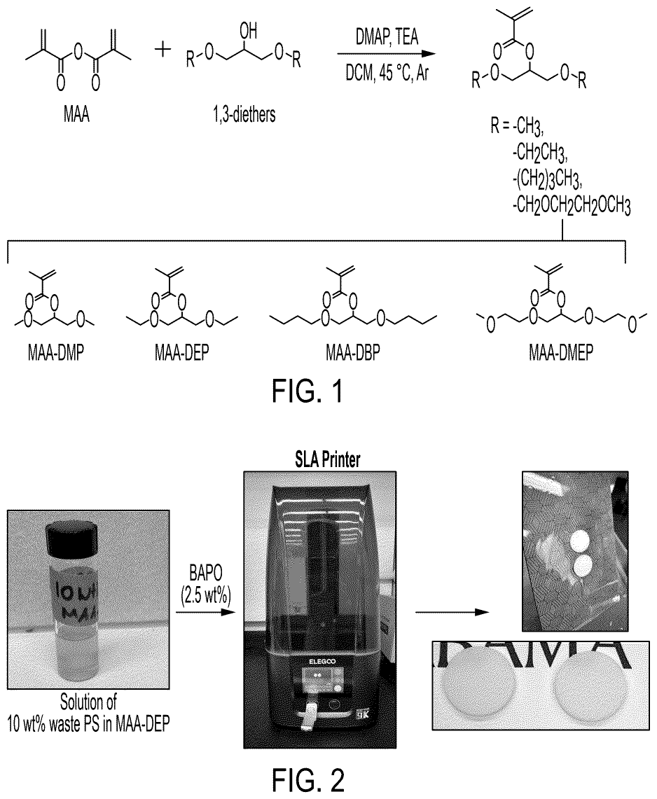

The general synthesis of MAA-DEP and other monomers is shown in FIG. 1. The procedure for MAA-DEP is as follows: DEP (20 g, 141 mmol) of DEP and 0.1 eq of DMAP were introduced to a 250 mL round bottom flask. Dichloromethane (DCM) (60 mL) and Et₃N (1.5 eq) were added under argon atmosphere, followed by the dropwise addition of 1.1 eq (155 mmol, 23.1 mL) of methacrylic anhydride (MAA) at room temperature. The final mixture was heated at 45° C. while stirring for 24 h. The solvent was removed under vacuum and the white solid was filtered. The filtrate was diluted by DCM and washed with saturated NaHCO₃ and water several times, before drying over anhydrous MgSO₄. Finally, the solvent was removed via rotary evaporation under reduced pressure and dried under vacuum overnight (Yield: 23 g, 85%).

Three additional monomers: 1,3-dimethoxypropan-2-yl methacrylate (MAA-DMP), 1,3-dibutoxypropan-2-yl methacrylate (MAA-DBP), and 2,5,9,12-tetraoxatridecan-7-yl methacrylate (MAA-DMEP) were synthesized in the same manner at similar scales from the reaction between corresponding symmetric 1,3-diether-2-propanol compounds and MAA in the presence of Et₃N and DMAP as a catalyst. The densities (r) and viscosities (m) of 1,3-diether-2-methacrylates at 25° C. and atmospheric pressure are shown below.

| Monomer | r (g · cm⁻³) | m (mPa · s) |
|---|---|---|
| MAA-DMP | 1.01106 | 2.57 |
| MAA-DEP | 0.96981 | 2.80 |
| MAA-DBP | 0.94817 | 5.53 |
| MAA-DMEP | 1.05053 | 4.95 |
| MAA-DEP/PS (10 wt %) | — | 166.25 |

### 3-D Printing of 1,3-Diether-2-Methacrylates

To prepare resins for SLA 3D printing, BAPO initiator was added at 2.5 wt % to a certain amount of each monomer and stirred for 10 min until a clear solution was observed. A bottom-up scanning SLA system (Elegoo Mars 4 MSLA, China) with a 405 nm light source was employed for sample fabrication. The exposure time is 40 s and the thickness of each layer is 50 m. After printing, the unreacted monomer was removed from the surface of the 3D-printed specimens and cleaned with 2-propanol for 10 min. The printed specimens were then post-cured in a UV oven (Elegoo Mercury Plus) for 10 min.

### Characterization

¹H NMR spectra were collected on a 500 MHz Bruker Avance instrument (Billerica, MA, USA). Viscosities of the four symmetric 1,3-diether-2-methacrylates were measured using a Brookfield DV-II Pro viscometer with a ULA spindle and jacketed sample cell at 25° C. and atmospheric pressure. Temperature control (±0.01° C.) was maintained automatically by a Brookfield TC-602P circulating bath. The density of synthesized monomers was determined using a Mettler Toledo DM45 DeltaRange densitometer at 25° C. and atmospheric pressure. The glass transition temperatures (T_{g}) of the polymers were determined by differential scanning calorimetry (DSC) (TA Instruments DSC Q20, New Castle, DE, USA) from −40 to 150° C. at a scan rate of 10° C. min⁻¹ under an N₂ atmosphere. Heating and cooling cycles were repeated at least three times to ensure reliable and reproducible results. To perform the TGA measurements, an appropriate amount of 3D printed polymer sample was packed in a high-purity cylindrical alumina (Al₂O₃) pan and heated from 25 to 700° C. at a ramp rate of 10° C. min⁻¹ under a constant flow rate (10 mL min⁻¹) of ultra-high purity Ar gas (UHP300, Airgas). Tensile testing was conducted utilizing a compact table-top electromechanical-driven single-column load-frame universal testing machine (Test Resources Inc, Shakopee, MN, USA) equipped with a 1.1 kN load cell capacity and a speed range of 0.01 to 30 in/min controlled by Newton software. The mechanical properties of the specimens were assessed at a controlled environment of 21 2° C. under ASTM D 638 standards 82 mm×12 mm×2 mm.

The degree of C═C double bond conversion (DC, %) in 3D-printed specimens was determined using Fourier transform infrared spectroscopy (FTIR) with a PerkinElmer Spectrum Two ATR-FTIR instrument. This was based on changes in the absorption intensity of the methacrylate C═C stretching vibration at 1638 cm⁻¹ before and after photopolymerization. The C═O stretching vibration between 1715 and 1725 cm⁻¹ was used as an internal standard. The DC was calculated using the following equation:

$$DC ( \% ) = ( 1 - \frac{{( \frac{{A}_{C = C}}{{A}_{C = O}} )}_{Plymer}}{{( \frac{{A}_{C = C}}{{A}_{C = O}} )}_{Monomer}} ) \times 100$$

where A_{C═C} represents the absorbance at 1638 cm⁻¹ before and after photopolymerization, while A_{C═O} refers to the absorbance peak around 1715-1725 cm⁻¹ in the monomer and polymer.

SEM images were captured to analyze the morphology of a 3D-printed sample prepared from a 10 wt % solution of PS in MAA-DEP. The samples were cryogenically fractured in liquid N₂, and the fractured surfaces were coated with a thin layer of silver to enhance conductivity. The analysis was conducted using a Thermo Fisher Scientific Apreo 2 SEM instrument operating at 5 kV. XRD measurements were performed on a Panalytical MPD X'pert Pro diffractometer (Model: PW3050/60).

The polymerization rate is correlated with its initial viscosity, as viscosity influences the mobility of both monomers and free radicals. This is an important factor in resins used for 3D printing. The structural resolution will be compromised if the resin's viscosity is extremely high or low. Viscosities <3 Pa·s (3000 mPa·s) at room temperature have effectively produced high-resolution objects using rapid prototyping techniques. The density of all samples ranges from 0.95 g cm⁻³ to 1.01 g cm⁻³. The viscosity of the monomers increased with the length of the R group chain (see FIG. 1). The MAA-DMP monomer (R: —CH₃) exhibited the lowest viscosity at 2.57 mPa s, while the viscosity of MAA-DBP (R: —(CH₂)₃—CH₃) more than doubled to 5.53 mPa s. The MAA-DMEP monomer, which has two additional ether groups instead of alkyl chains, displayed a viscosity close to 5 mPa s. It is important to note that the newly synthesized monomers are not directly comparable to commercial resins in terms of viscosity, as the latter are typically optimized with several additives. Conventional resins usually exhibit viscosities in the range of 200 to 1500 mPa s. The 1,3-diether-2-methacrylate monomers can be used as the main component for resin formulation, with viscosity adjusted using crosslinkers and comonomers. Despite the lower viscosity, the printed specimens still exhibited acceptable resolution.

A special property of 1,3-diether-2-methacrylate monomers, including MAA-DEP, is the ability to dissolve PS (FIG. 2). The viscosity of a 10 wt % waste PS (M_{w}=170 kDa) solution in MAA-DEP is also presented in the table, showing an increase of ~60× from 2.80 to 166.25 mPa s upon dissolving waste PS with relatively high molecular weight.

The degree of C═C double bond conversion (DC %) of the methacrylate groups to polymer was quantified by measuring the reduction in peak absorption intensity at 1638 cm⁻¹, relative to an internal standard (C═O absorption band at 1717-1725 cm⁻¹) that remained unchanged during polymerization. The DC % is a critical parameter for evaluating the photocuring reactivity of resins, and as shown in Table 2, the DC % was ~80% across all resins under the printing conditions used. Even in the MAA-DEP/PS10 system, nearly all double bonds were polymerized. This high conversion is likely due to the low viscosity of the 1,3-diether-2-methacrylate monomers, which enhances the mobility of free radicals of the monomers and the growing polymer chains. In contrast, some resins like Bis-GMA, a commonly used monomer in dental composite resins, typically exhibit lower DC values (typically around 55-70%). The high viscosity of Bis-GMA, its rigid bisphenol A (BPA) backbone, and extensive H-bonding restrict polymer chain movement during polymerization, leading to lower conversion rates compared to the more flexible and less viscous 1,3-diether-2-methacrylate monomers synthesized in this work, which share structural commonalities with of alkyl methacrylates and poly(ethylene glycol) methacrylates. The degree of conversion, thermal properties and average tensile test results of the 3D printed specimens are presented below:

| | | | | Young's | Tensile | Elongation |
|---|---|---|---|---|---|---|
| | DC | T_{g} | T_{d, max}¹ | modulus | strength | at break |
| Polymer | (%) | (° C.) | (° C.) | (MPa) | (MPa) | (%) |
| Poly(MAA-DMP) | 80.2 | 19.30 | 320 | — | — | — |
| Poly(MAA-DEP) | 78.3 | 0.29 | 291 | 7.67 ± 0.287 | 1.61 ± 0.097 | 142.94 ± 7.75 |
| Poly(MAA-DEP)/ | 80.6 | 0.72 & | 301 | 29.83 ± 1.01 | 3.67 ± 0.159 | 91.49 ± 6.90 |
| PS10 | | 95.82 | | | | |
| Poly(MAA-DBP) | 82.1 | 27.17 | 326 | 8.25 ± 0.279 | 1.41 ± 0.150 | 22.87 ± 2.68 |
| Poly(MAA-DMEP) | 80.7 | 26.17 | 309 | 2.17 ± 0.087 | 0.703 ± 0.084 | 42.90 ± 6.82 |

¹Maximum decomposition temperature as measured by TGA

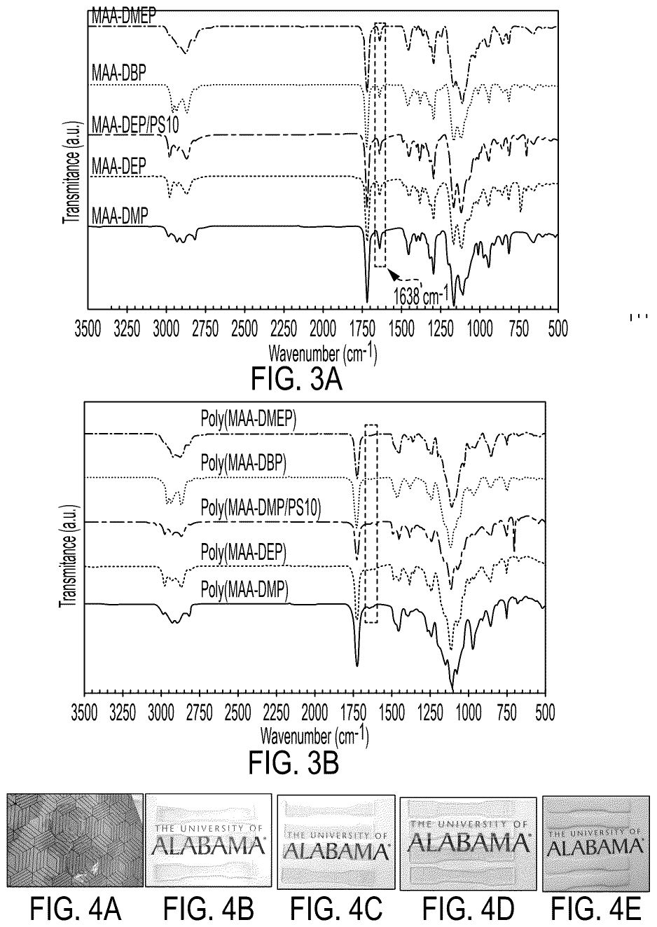

An SLA 3D printer was utilized to evaluate the suitability of the newly developed 1,3-diether-2-methacrylate monomers for additive manufacturing. BAPO (lₘₐₓ~370 nm) was used as the photoinitiator for 3D printing. All monomers were successfully printed as shown in FIG. 4. However, the poly(MAA-DMP) printed specimens presented challenges during removal from the build plate, resulting in breakage (FIG. 4a).

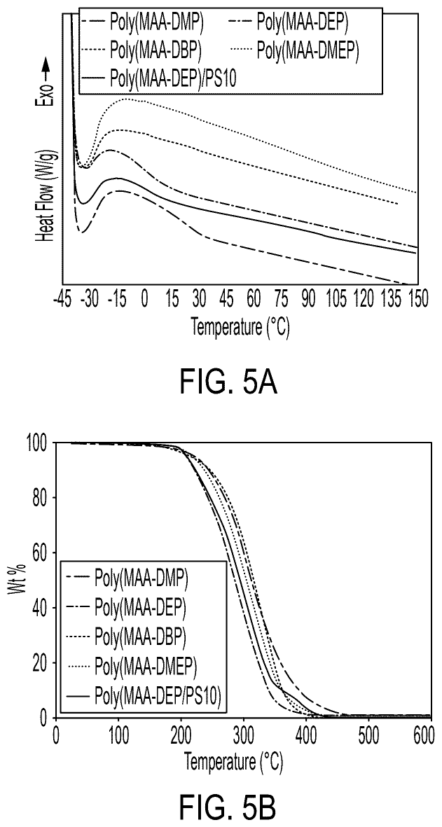

The thermal properties of the samples were analyzed using differential scanning calorimetry (DSC) and thermogravimetric analysis (TGA). FIG. 5a and the table above present the glass transition temperatures (T_{g}) of the 3D-printed polymers. The T_{g} of poly(MAA-DMP) was found to be 19.3° C., which sharply decreased to 0.29° C. in poly(MAA-DEP). This suggests that adding a single methylene group to each ether moiety significantly increases the flexibility of the polymer chains. In contrast, the longer alkyl side chains in poly(MAA-DBP) and the incorporation of two extra ether groups in the side chain of the MAA-DMEP monomer had the opposite effect, increasing T_{g} to approximately room temperature. One possible explanation for the increase in T_{g} with longer alkyl side chains can be attributed to the greater steric hindrance, restricted chain mobility, and chain entanglement imposed by these longer substituents. These longer alkyl groups can increase the polymer's bulkiness, reducing the degree of freedom for the polymer chains' rotation and movement, leading to increased rigidity and a higher T_{g}. A similar shift toward higher T_{g} was observed for poly(MAA-DMEP) where the dipole-dipole interactions between extra ether groups might further restrict the movement of the polymer backbone, contributing to the elevated T_{g}.

The polymer blend produced by the photopolymerization of MAA-DEP with dissolved PS revealed two T_{g} values. The first, at 0.72° C., corresponds to poly(MAA-DEP), while the second, at 95.82° C., is attributed to the PS fraction. The presence of two T_{g} values in the DSC profile of poly(MAA-DEP)/PS10 suggests possible phase separation between the two polymers. The microstructure of this sample will be presented and discussed in the upcoming section to understand the interaction between the two polymers after 3D printing.

TGA analysis was conducted to assess the thermal stability of the 3D-printed polymer. FIG. 5b shows the samples exhibit almost similar thermal behavior, with minor variations due to slight structural differences. Thermal decomposition primarily occurred in a single stage. The weight loss below 200° C. was <3% for all samples, with an initial decomposition temperature of around 200° C. The maximum decomposition temperature (T_{d,max}), presented in the table above, was 326° C. for Poly(MAA-DBP) and 291° C. for Poly(MAA-DEP), indicating moderate thermal stability. The TGA of Poly(MAA-DEP/PS10) shows a distinct but minor decomposition step after the primary decomposition (T_{d,max}=301° C.), corresponding to a 10 wt % weight loss attributed to PS degradation.

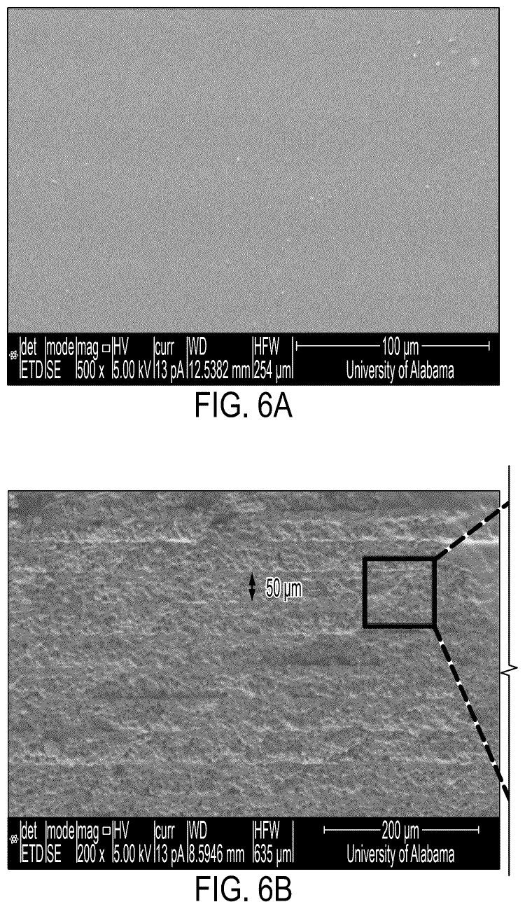

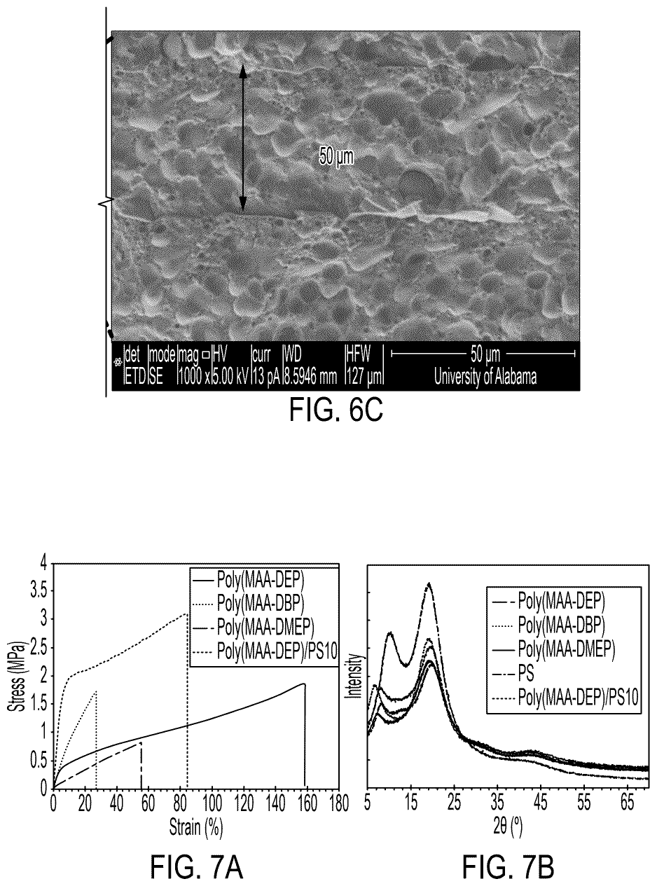

The microstructures of the cryo-fractured surfaces of pure poly(MAA-DEP) and poly(MAA-DEP) containing 10 wt % dissolved PS are shown in FIG. 6. In FIG. 6a, the fracture surface of pure MAA-DEP exhibits a smooth and homogeneous texture, with no visible evidence of individual printed layers. In contrast, the unique layer-by-layer structure of the 3D-printed sample, with a layer thickness of 50 μm, is clearly observed in the poly(MAA-DEP)/PS blend (FIG. 6b). This is the first report on preparing a 3D-printed blend by dissolving a thermoplastic in a monomer using SLA. From FIG. 6c, the PS phase is almost homogeneously dispersed within the main MAA-DEP polymer matrix, with spherical PS domains predominantly concentrated at the top of each layer. It appears that during curing, the poly(MAA-DEP) matrix tends to push the dissolved PS toward the top of each layer. This results in a slightly higher concentration of spherical PS domains with diameters ranging from 0.2 μm to 2 μm at the layer tops. The sponge-like structure observed at the top of each layer, with a thickness of approximately 10 μm, may be attributed to this phenomenon. Additionally, these phase boundaries scatter light, leading to reduced transparency and causing the material to appear translucent/opaque (FIG. 2). This morphology is expected to influence the mechanical properties of the resulting 3D-printed blend. While polymer blends are typically synthesized through melt blending in equipment such as extruders, the dual functions of MAA-DEP as both a monomer and a solvent provide an innovative approach to preparing polymer blends through a fundamentally different method.

Tensile tests were conducted on the 3D-printed dogbone specimens (FIG. 5b-e) to evaluate the effects of the chemical structure of 1,3-diether-2-methacrylates on the mechanical properties of the resultant polymers. The average tensile strength (MPa), Young's modulus (MPa), and elongation at break (%) are summarized in the table above, and the stress-strain curves are shown in FIG. 7a. Poly(MAA-DEP) and Poly(MAA-DBP) exhibit similar Young's modulus values of 7.67 and 8.25 MPa, respectively, indicating they are stiffer than Poly(MAA-DMEP), which has Young's modulus of 2.17 MPa. The maximum tensile strength of 1.61 was observed for Poly(MAA-DEP), which is more than twice that of Poly(MAA-DMEP) (0.703 MPa). In terms of elongation at break, Poly(MAA-DEP) also demonstrated a superior strain of approximately 143%, which is more than 6× that of Poly(MAA-DMEP). These results show the mechanical properties of these 3D-printed polymers depend significantly on the chemical structure of the 1,3-diether-2-methacrylate monomers. Poly(MAA-DEP) demonstrates the best mechanical performance within the series, indicating that its chemical structure is optimal for achieving 3D-printed items with mechanical properties comparable to some thermoplastic polyurethane (TPU) and poly(ether-block-amide) materials. These properties make it suitable for applications demanding flexibility and elasticity, such as footwear, sporting goods, medical devices, and seals. The strength and performance of the resulting polymers can be customized by formulating a resin with different crosslinkers, co-monomers, and filler-filling reinforcement. Dissolving waste PS at 10 wt % in MAA-DEP significantly enhances the tensile properties of the 3D-printed polymer (FIG. 7a). The tensile strength more than doubles compared to that of poly(MAA-DEP), and Young's modulus increases approximately four-fold, reaching ~30 MPa. This increase is attributed to the inherent high tensile strength and modulus of PS. The reduction in elongation at break to nearly 90% is due to the formation of rigid PS domains (FIG. 6) during the photopolymerization of MAA-DEP, which restricts the overall flexibility of the material, making it stiffer and less stretchable.

X-ray diffraction (XRD) is a non-destructive technique used to analyze the morphology of polymers and their blends. FIG. 7b presents the diffractograms of 3D-printed 1,3-diether-2-methacrylate polymers within the 20 range of 5° to 70°. The XRD spectra of all 3D-printed 1,3-diether-2-methacrylate polymers exhibit a predominantly amorphous nature, characterized by the absence of sharp, distinct diffraction peaks. For example, the diffractogram of poly(MAA-DEP) displays four broad peaks at 20 values of 8.01°, 19.76°, 32.74°, and 43.97°, with a gradual decrease in peak intensity. Variations in the pendant groups of the monomers do not induce crystallinity in the resulting polymers and do not have a significant effect on the peak positions.

Neat PS exhibits two distinct broad peaks at 9.890 and 19.10°, confirming its amorphous character. Incorporating 10 wt % PS into MAA-DEP, followed by 3D printing, resulted in a blend without altering the peak positions in the XRD spectra. This consistency further supports the uniform distribution of the PS in the blend.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches

What is claimed is:

1. A composition, comprising a compound having the formula: 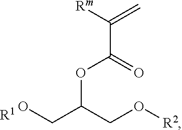
wherein
R^{m} is H or CH₃;
R¹ is C₁₋₁₂alkyl, C₃₋₁₂cycloalkyl, C₁₋₁₂heteroalkyl, C₆₋₁₂aryl, C₁₋₁₂heteroaryl, wherein R¹ can be substituted one or more times by halo, hydroxy, C₃₋₈cycloalkyl, C₁₋₈heterocyclyl, C₆₋₁₂aryl, C₁₋₁₂heteroaryl, or a combination thereof, and
R² is C₁₋₁₂alkyl, C₃₋₁₂cycloalkyl, C₁₋₁₂heteroalkyl, C₆₋₁₂aryl, C₁₋₁₂heteroaryl, wherein R² can be substituted one or more times by halo, hydroxy, C₃₋₈cycloalkyl, C₁₋₈heterocyclyl, C₆₋₁₂aryl, C₁₋₁₂heteroaryl, or a combination thereof.

2. The composition of claim 1, wherein R¹ comprises a saturated C₁₋₁₂alkyl or an unsaturated C₁₋₁₂alkyl, methyl, ethyl, propyl, allyl, isopropyl, n-butyl, isobutyl, sec-butyl, t-butyl, n-pentyl, n-hexyl, n-heptyl, or 2-ethylhexyl, cyclopropyl, cyclobutyl, cyclopentyl, cyclohexyl, benzyl, phenyl, cinnamyl, 2,2,2-trifluoroethyl, trifluoromethyl, pentafluoroethyl, 2-methylphenyl, 3-methylphenyl, 4-methylphenyl, propargyl, furfuryl, diphenylmethyl, 2-phenylethyl, menthyl, cyclohex-3-enyl, geranyl, (+)-citronellol, (−)-citronellol, neryl, nerolidyl, linaloolyl, 2-yl-benzoate methyl ester, er thymyl, 2-methoxyethyl, 2-ethoxyethyl, 3-methoxypropyl, 3-ethoxypropyl, —(CH₂CH₂O)~—CH₃, —(CH₂)ₙ—O(CH₂)ₘ—CH₃, —(CH₂)ₙ—O(CF₂CF₃), wherein n is 1, 2, 3, 4, 5, or 6, and m is 1, 2, 3, 4, 5, or 6.

3. The composition of claim 2, wherein R² comprises a saturated C₁₋₁₂alkyl or an unsaturated C₁₋₁₂alkyl, methyl, ethyl, propyl, allyl, isopropyl, n-butyl, isobutyl, sec-butyl, t-butyl, n-pentyl, n-hexyl, n-heptyl, or 2-ethylhexyl, cyclopropyl, cyclobutyl, cyclopentyl, cyclohexyl, benzyl, phenyl, cinnamyl, 2,2,2-trifluoroethyl, trifluoromethyl, pentafluoroethyl, 2-methylphenyl, 3-methylphenyl, 4-methylphenyl, propargyl, furfuryl, diphenylmethyl, 2-phenylethyl, menthyl, cyclohex-3-enyl, geranyl, (+)-citronellol, (−)-citronellol, neryl, nerolidyl, linaloolyl, 2-yl-benzoate methyl ester, thymyl, 2-methoxyethyl, 2-ethoxyethyl, 3-methoxypropyl, 3-ethoxypropyl, —(CH₂CH₂O)ₙ—CH₃, —(CH₂)ₙ—O(CH₂)ₘ—CH₃, —(CH₂)~—O(CF₂CF₃), wherein n is 1, 2, 3, 4, 5, or 6, and m is 1, 2, 3, 4, 5, or 6.

4. The composition of claim 1, wherein the composition comprises a dissolved polymer.

5. The composition of claim 4, wherein the dissolved polymer comprises a concentration from 0.5-50 wt. %, from 1-50 wt. %, from 1-25 wt. %, from 1-10 wt. %, from 1-5 wt. %, from 5-10 wt. %, from 5-25 wt. %, from 10-20 wt. %, from 10-25 wt. %, from 10-50 wt. %, or from 25-50 wt. %.

6. The composition of claim 5, wherein the dissolved polymer comprises a polyolefin, including fluoropolymers, a polyester, a polyurethane, a polyamide, a polycarbonate, poly(meth)acrylate, polyethylene, polypropylene, polystyrene, polyvinyl chloride, polytetrafluoroethylene, polyvinyl fluoride, polyvinylidene fluoride, polyhexafluoropropylene, polyperfluorocycloalkene, perfluoropolyether, polychlorotrifluoroethylene, polyvinyl acetate, polyvinyl alcohol, polyurethane, polyamide 6, polyamide 66, polyamide 6T, polyamide, 4,6, polyamide 6,10, polyamide 6,12, polyacrylonitrile, polycarbonate, polylactic acid, polyethylene terephthalate, poly(propylene terephthalate), poly(methyl methacrylate), poly(butyl acrylate), poly(vinylimidazole), polyvinylpyrrolidone, poly(vinylpyridine), a combination thereof, or a copolymer thereof.

7. The composition of claim 6, further comprising a crosslinker, wherein the crosslinker comprises bis(meth)acrylate, bis(meth)acrylamide, divinyl compound, or a crosslinker comprising the formula: 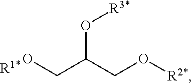
wherein
R¹* is C₁₋₈alkyl, C₃₋₈cycloalkyl, C₁₋₈heteroalkyl, allyl, or (meth)acrylyl;
R²* is C₁₋₈alkyl, C₃₋₈cycloalkyl, C₁₋₈heteroalkyl, allyl, or (meth)acrylyl;
R³* is C₁₋₈alkyl, C₃₋₈cycloalkyl, C₁₋₈heteroalkyl, allyl, or (meth)acrylyl;
wherein (meth)acrylyl independently has formula: 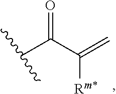
provided that at least two of R¹*, R²*, and R³* are allyl or (meth)acrylyl group

8. The composition of claim 7, wherein the crosslinker comprises methylene bisacrylamide, ethylene glycol dimethacrylate, tetraethylene glycol dimethacrylate, trimethylolpropane trimethacrylate, ethoxylated trimethylol triacrylate, ethoxylated pentaerythritol tetracrylate, glycol (PEG)-thiol/PEG-acrylate, acrylamide/N,N′-bis(acryloyl)cystamine (BACy), (meth)acrylate-oligolactide-PEO-oligolactide (meth)acrylate, N,N′bis(acryloyl)cystamine, bisacrylamide, diacrylate, diallylamine, triallylamine, divinyl sulfone, diethylene glycol diallyl ether, ethylene glycol diacrylate, polyethylene glycol diacrylate, 1,4-phenylenediacryloyl chloride, or combinations thereof.

9. The composition of claim 8, wherein the crosslinker comprises a concentration from 0.01-20 wt. %, from 0.1-10 wt. %, from 0.1-5 wt. %, from 0.1-2.5 wt. %, from 1-2.5 wt. %, from 1-5 wt. %, from 1-10 wt. %, or from 5-10 wt. %.

10. A method of making an article, comprising polymerizing the composition of claim 1.

11. The method of claim 10, wherein the polymerizing comprises exposing the composition to actinic radiation, heating the composition, or a combination thereof.

12. The method of claim 11, wherein the composition comprises one or more initiator species.

13. The method of claim 12, wherein the composition comprises a photoinitiator, a thermal initiator, or combination thereof.

14. The method of claim 13, wherein the initiator comprises 1,1-azobis (cyclohexanecarbonitrile), ammonium persulfate, benzoyl peroxide, di-t-amylperoxide, tert-butyl peroxybenzoate, dicumylperoxide, azobisisobutyronitrile (AIBN), sodium metabisulfite, 4,4-azobis(4-cyanovaleric acid), 2,2-azobis(2,4-dimethylpentanenitrile), 2,2-azobis(cyclohexanecarbonitrile, Acetophenone, 2-phenylacetophenone, 2-hydroxy-2-methylpro piophenone, 4-hydroxybenzophenone, 4,4-dihydroxybenzophenone, 4-(dimethylamino) benzophenone 4-ethoxyacetophenone, 4-phenoxyacetophenone, hexafluorophosphate, anthraquinone, anthraquinone-2-sulfonic acid, sodium salt monohydrate; tricarbonylchromium, benzoin based initiators, benzoin methyl ether, benzoin isobutyl ether, 2-hydroxy-4-(2-hydroxy ethoxy)-2-methylpropiophenone, benzil ketal based initiators dialkoxyacetophenone, hydroxyphenone, phenyl ketone, aminoalkylphenone, acylphosphine oxide, benzophenone, thioxanthone, azobisisobutyronitrile, lithium phenyl-2,4,6-trimethylbenzoylphosphinate, 1-hydroxy-cyclohexylphenylketone or blends, benzophenone tetracarboxylic dianhydride, methybenzoylformate, phenanthrenequinone, ferrocene, triarylsulfonium hexafluorophosphate salt, phenylbis(2,4,6-trimethylbenzoyl) phosphine oxide, and combinations thereof.

15. The method of claim 14, wherein the initiator comprises a concentration from 0.01-10 wt. %, from 0.1-5 wt. %, from 0.1-2.5 wt. %, from 0.1-1 wt. %, from 0.1-0.5 wt. %, from 1-5 wt. %, from 1-2.5 wt. %, from 2.5-7.5 wt. %, or from 5-10 wt. %.

16. A method of upcycling a polymer, comprising dissolving the polymer in a compound having the formula: 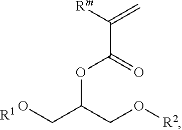
wherein
R^{m} is H or CH₃;
R¹ is C₁₋₈alkyl, C₃₋₈cycloalkyl, or C₁₋₈heteroalkyl; and
R² is C₁₋₈alkyl, C₃₋₈cycloalkyl, or C₁₋₈heteroalkyl.

17. The method of claim 16, wherein the polymer is added to the compound at a concentration from 0.5-50 wt. %, from 1-50 wt. %, from 1-25 wt. %, from 1-10 wt. %, from 1-5 wt. %, from 5-10 wt. %, from 5-25 wt. %, from 10-20 wt. %, from 10-25 wt. %, from 10-50 wt. %, or from 25-50 wt. %.

18. The method of claim 16, wherein the polymer comprises a polyolefin, including fluoropolymers, a polyester, a polyurethane, a polyamide, a polycarbonate, poly(meth)acrylate, copolymers thereof, or a combination thereof.

19. The method of claim 16, wherein the polymer comprises a polyethylene, polypropylene, polyvinyl chloride, polytetrafluoroethylene, polyvinyl fluoride, polyvinylidene fluoride, polyhexafluoropropylene, polyperfluorocycloalkene, perfluoropolyether, polychlorotrifluoroethylene, polyvinyl acetate, polyvinyl alcohol, polyurethane, polyamide 6, polyamide 66, polyamide 6T, polyamide, 4,6, polyamide 6,10, polyamide 6,12, polyacrylonitrile, polycarbonate, polylactic acid, polyethylene terephthalate, poly(propylene terephthalate), poly(methyl methacrylate), poly(butyl acrylate), poly(vinylimidazole), polyvinylpyrrolidone, poly(vinylpyridine), a combination thereof, or a copolymer thereof.

20. The method of claim 16, wherein the polymer is polystyrene.
